(19) United States
(12) Patent Application Publication
(10) Pub. No.: US 2023/0242335 A1
(43) Pub. Date: Aug. 3, 2023

(54) Divided Trash Can

(71) Applicant: Jason Craig Turman, Middleburg, FL (US)

(72) Inventor: Jason Craig Turman, Middleburg, FL (US)

(21) Appl. No.: 17/592,107

(22) Filed: Feb. 3, 2022

(51) Int. Cl. B65F 1/12; B65F 1/14

(52) U.S. Cl. CPC B65F 1/12; B65F 1/14

(57) ABSTRACT

The device is a trash can that is comprised of two sections that can either be separated completely or rotated to expose the bottom section of a trash can. The bottom section can then be cleaned easily and the trash can is then reassembled either by attaching the two sections or by rotating the sections and clamping the sections together.

### PRIOR FILED APPLICATION

The applicant filed a prior Non-Provisional Application on Feb. 20, 2020 with the corresponding Application No. 16795731. The examiner required restriction of the parent application and this application is filed as a divisional application from the parent application. The applicant claims the benefit of the priority date of Feb. 20, 2020 from the parent application with this filing.

### FIELD OF THE INVENTION

For this invention, this relates to being able to clean the bottom portion or base the trashcan easily and comfortably. In this device, the trashcan can be separated in two distinct pieces, while the base can be cleaned and then reattached. Additionally, there are a pair of hand holes which prevent the build up of the vacuum which is typically found in trashcans.

### PRIOR ART

There are many prior art references to trashcans and trash collection devices. A representative example of this can be found at Thoma, U.S. Pat. No.: 10233018, which is a trashcan that sits on a base. This relates mainly to the base and not being able to clean the base. Thoma, discusses a one-piece trashcan. Another reference can be found at Stany, U.S. Pat. No.: 6594876. This is kit for modifying existing trashcans to minimize or to the prevent occurrence of a vacuum seal that may occur when a trashcan liner is pulled out of the trashcan. This, like the prior reference, is also a one-piece trashcan as opposed to a two-piece sectional trashcan. Another reference can be found at Yang, U.S. Pat. No.: 6626316, which is a trashcan assembly with an appropriate recess. Again, this is a one-piece trashcan.

Another Yang reference can be found at Yang, U.S. Pat. No.: 7044323, which is a detachable foot pedal for trashcan. Again, this is a one-piece trashcan and is not intended to be separated.

Additionally another reference is Yang, U.S. Publication: 2010/0147865, which is a step trashcan having an integrated base and base liner. This does not obviate the problem for cleaning the base or the bottom portion of the trashcan. Again, like the other references this is a single trashcan, not a sectional trashcan.

### BRIEF SUMMARY OF THE INVENTION

This is a trashcan which can be separated in two pieces. The trashcan may be slightly tapered or cubic. Additionally, the trashcan may also be circular.

Near the bottom, but not at the bottom, is a means to separate the trashcan. This may be done by a pair of mating rims that will join the top section to the bottom section. This joinder may also be accomplished by a plurality of posts on the underside of the top section that correspond to posts on the top surface of the bottom section. The posts and openings would align when the two sections are joined together. The user would pull up on the top section while holding the bottom section and unsnap the trashcan into the two sections.

The upper section of the trashcan can be put aside, while the bottom section of the trashcan is cleaned. Once the bottom section is cleaned, the trashcan can then be reassembled and be used as an ordinary trashcan.

Additionally, there are a pair of holes near the top to prevent the vacuum seal which is commonplace in this type of trash can. The vacuum makes it more difficult to pull the sections apart.

In an alternative embodiment the top section and bottom sections are hinged together. A clamp or clamps may be placed on the opposite side of the hinge. When the person is cleaning the bottom section the user would release the clamp on the surface and rotate the trash can. When the bottom section is cleaned the top section is rotated onto the bottom section and re-clamped.

### BRIEF DESCRIPTION OF THE DRAWINGS

FIG. 1 is a front isometric view of the trashcan.

FIG. 2 is an exploded view of the trashcan.

FIG. 3 is a bottom isometric view of the upper section of the trashcan.

FIG. 4 is a front view of the trashcan.

FIG. 5 is a side view of the trashcan.

FIG. 6 is a cross-sectional view of the trashcan.

FIG. 6A is a view of the post on the top surface of the bottom section and the opening on the bottom surface of the top section.

FIG. 7 is an isometric view of the alternative embodiment.

FIG. 8 is a back view of the alternative embodiment.

FIG. 9 is a side view of the alternative embodiment depicting the rotation of the top section.

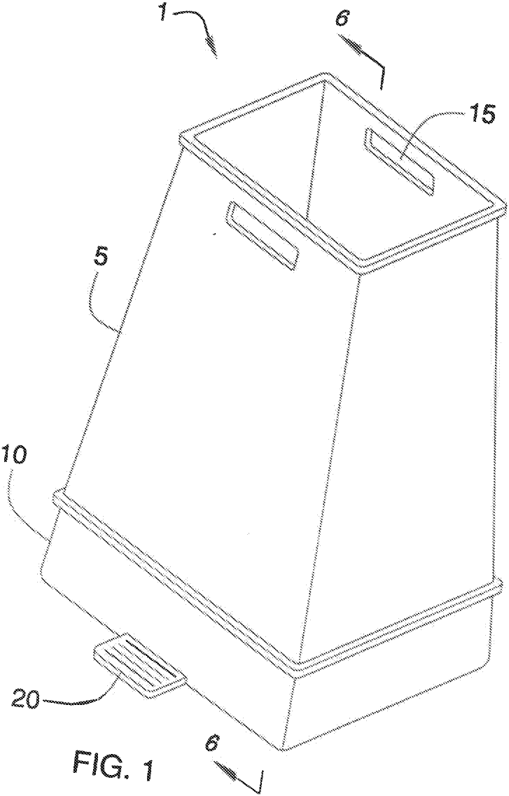

### NUMBERING REFERENCES

| | |
|---|---|
| 1 | Device |
| 5 | Top section |
| 10 | Bottom section |
| 15 | Hand Holes |
| 20 | Foot Pad |
| 25 | Securing Strip |
| 30 | Post |
| 35 | Opening on the bottom surface of the top section |
| 40 | Clamp |
| 45 | Hinge |

### DETAILED DESCRIPTION OF THE EMBODIMENTS

This is a sectional trashcan. Like most ordinary trashcans, the liner or bag is placed in the interior and will collect trash. The purpose of the trash bag is to prevent food particles and other waste products from reaching the bottom section of the trashcan. If trash and other debris does reach the bottom of the trashcan it will need to be cleaned periodically. This job is not desirable but it must be done to minimize the smells from trash debris.

Invariably, however, dirt, trash, grime and food products will accumulate at the bottom section of the trash can. This can be caused by a faulty bag that breaks or types of debris that will puncture the bag and allow for food waste to accumulate on the bottom of the trash can. This will occur even though a trash bag has been placed in the trash can. It is this accumulation of waste, dirt and grime that must be periodically cleaned. In order to clean the typical trashcan, one must insert his or her arm and extend to the bottom of the trashcan. This is sometimes uncomfortable and awkward depending on the length of the arm of the person cleaning the trash can.

In this device 1, the two sections (5, 10) of the trashcan are separated to expose the bottom section: the top section 5 is separated from the bottom section 10. The bottom section 10 can then be cleaned and the sections of the trash can then be reassembled. A foot pad 20 has been placed on the bottom section 10 to allow the person to easily remove the sections prior to cleaning. In order to provide a grip for the individual as the sections are separated, hand holes 15 are placed on the top section so that the person can place his or her foot on the foot pad 20 while pulling up on the top section.

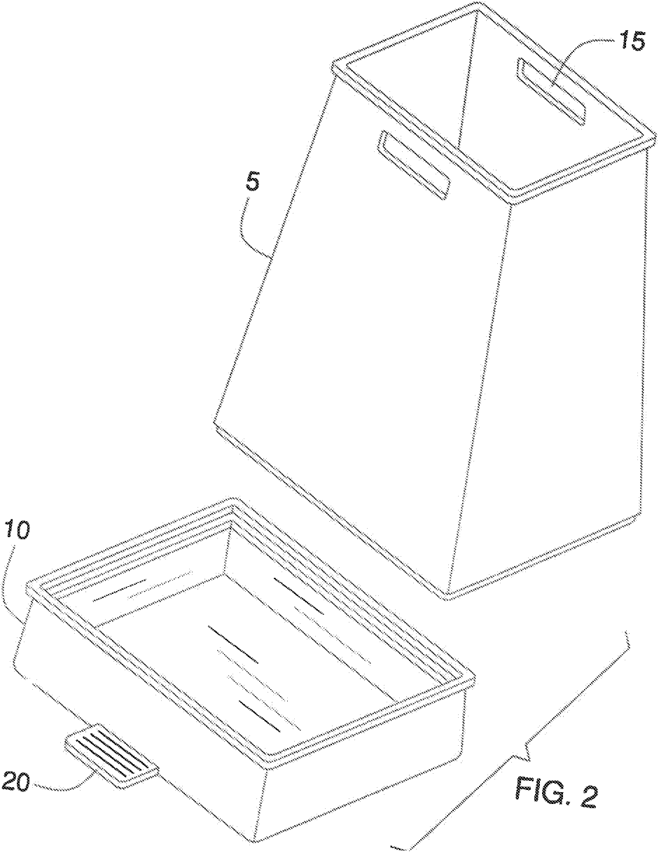

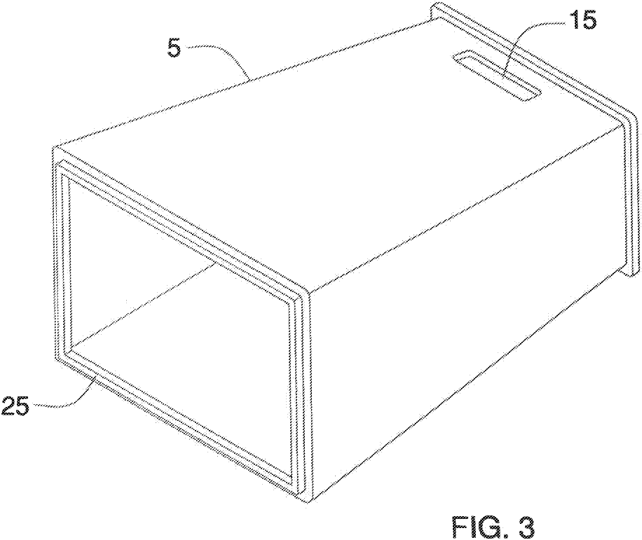

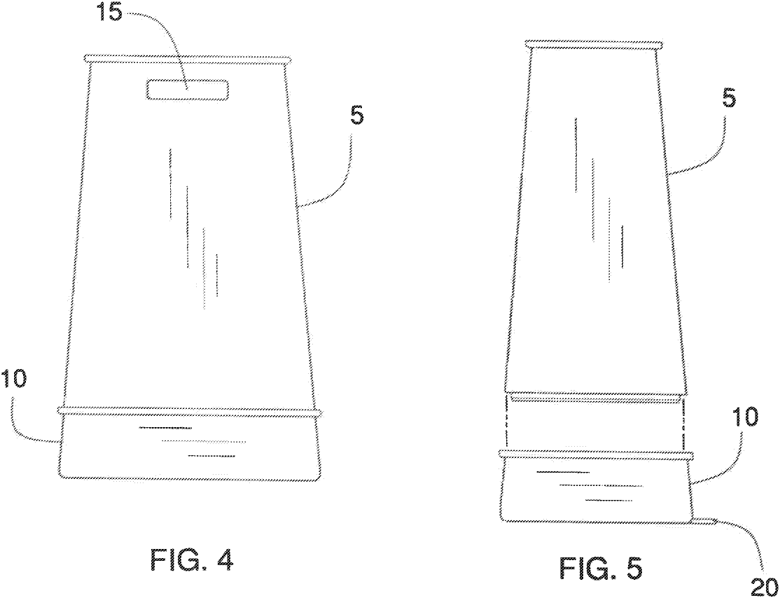

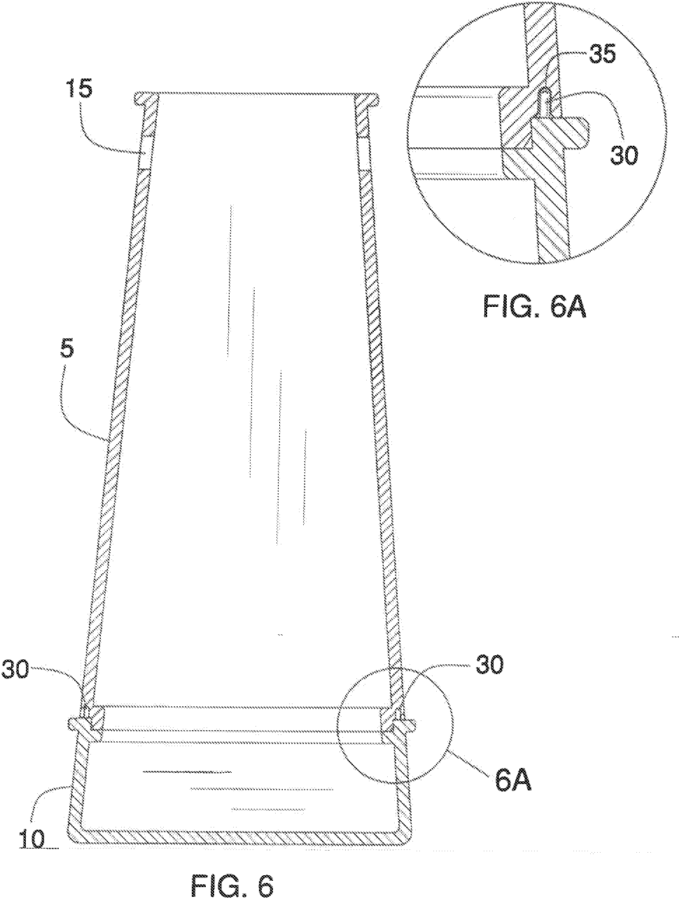

There are many ways to join the top section and the bottom section such as shown by FIG. 6. For instance, there may a post 30 and a corresponding opening 35 in the bottom and top sections respectively. Another way is to have a securing rim around the upper perimeter of the bottom section 10 that corresponds to a mating ridge on the bottom portion of the top section such as shown in FIG. 2. Another way is to have securing clamps (not depicted) on the top and bottom sections to join the pieces together.

Regardless of the exact means to join the two sections, the two sections will completely separate in this embodiment.

### ALTERNATIVE EMBODIMENT

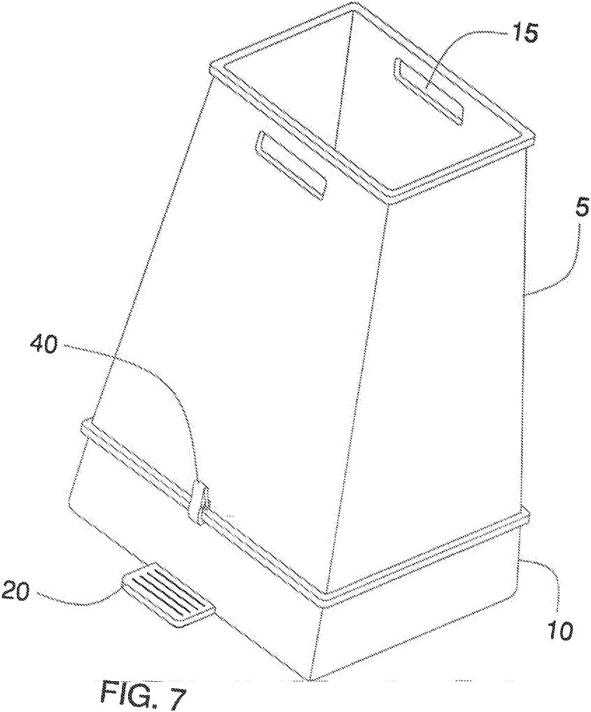

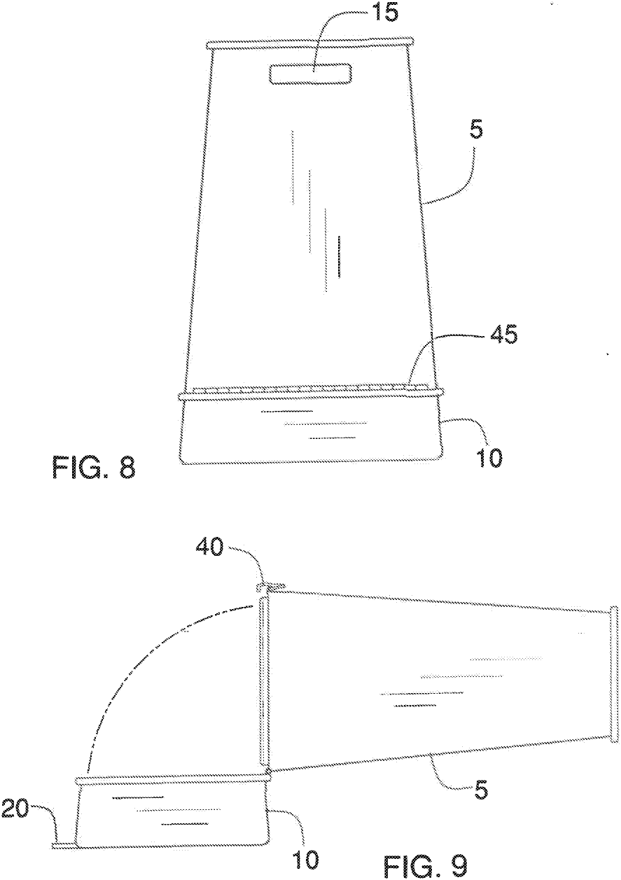

Another embodiment allows the two sections of the trash can to remain together. In this embodiment a hinge 45 is placed across the top 5 and bottom 10 sections. A clamp 40 is placed on the surface of the trashcan; a portion of the clamp is placed on the outside surface of the top section and a portion of the clamp is placed on the outside surface of the bottom section. The clamp is placed on the opposite side from the hinge such as depicted in FIGS. 7 and 9. When the bottom section is to be cleaned the user unclamps the two sections and rotates the top section backward to expose the bottom section such as depicted in FIG. 9. When the bottom section is cleaned the top section is rotated upwards and the two sections are again clamped together.

In this embodiment, the two sections are joined together at all times.

The inventor claims:

1. A trash can which is comprised of:
a top section;
wherein the top section is a predetermined shape;
a bottom section;
wherein the bottom section is a predetermined shape;
a hinge;
wherein the hinge joins the top section and the bottom section;
wherein the top section rotates away from the bottom section;
wherein a clamp is provided;
wherein a section of the clamp is provided on the outside surface of the bottom section;
wherein a section of the clamp is provided on the outside surface of the top section;
wherein the clamp secures the top section to the bottom section;
said clamp is on the opposite side of the hinge;
a foot pad;
wherein the foot pad is placed on the bottom section;
a pair of handholes;
wherein the handholes are placed on the top section.
